(19) United States
(12) Patent Application Publication
(10) Pub. No.: US 2003/0147652 A1
(43) Pub. Date: Aug. 7, 2003

(54) Optical free space signalling system

(76) Inventors: Alan Edward Green, Ickleton (GB); Euan Morrison, Ickleton (GB); Gordon Malcolm Edge, Ickleton (GB)

Correspondence Address: FOGG AND ASSOCIATES, LLC, P.O. BOX 581339, MINNEAPOLIS, MN, 55458-1339, US

(21) Appl. No.: 10/181,124

(22) PCT Filed: Jan. 15, 2001
(86) PCT No.: PCT/GB01/00139

(30) Foreign Application Priority Data
Jan. 14, 2000 (GB) 0000908.4

(51) Int. Cl. H04B 10/00

(52) U.S. Cl. 398/118; 398/58

(57) ABSTRACT

There is a described a free space optical signalling system in which data is transmitted from an optical transmitter to an optical receiver. The optical transmitter includes means for modulating one or more light beams in accordance with the data to be transmitted so as to generate a plurality of modulated light beams which are output from the optical transmitter as substantially collimated, spatially-separated, parallel free-space light beams. The optical receiver includes a plurality of detectors, each detector detecting a corresponding one of the plurality of modulated, parallel, free-space light beams and converting the detected light beam into a corresponding electrical signal from which the data can be recovered.

This invention relates to a signalling system. In particular, this invention relates to a signalling method and apparatus in which data is conveyed by modulating a light beam.

In recent years, the rapid increase in data transmitted over local area networks (LANs), wide area networks (WANs), the Internet and the like has prompted a large amount of research into increasing data transfer rates by using modulated optical beams to convey information. To date, this research has concentrated on systems in which the optical beams are transmitted along optical fibres.

A problem with using optical fibres is that the installation of the optical fibres can be expensive and time consuming. Further, in environments where high levels of ionising radiation are present (for example in nuclear reactors or particle colliders) the attenuation of optical fibres increases with time making their use problematic.

It has been proposed to use free space optical beams in communication links to remove the requirement for optical fibres. In conventional free space optical communication systems, the output of a laser source is modulated in accordance with a stream of data.

International Patent Applications WO 98/35328 and WO 00/48338, the whole contents of which are incorporated herein by reference, describe point-to-multipoint communication systems utilising free-space optical beams. The described systems are particularly advantageous for transmitting data from a distribution node (provided, for example, on a post in a street) to a plurality of user stations (provided, for example, on respective houses in the street) because they are relatively cheap and easy to install in comparison with providing optical fibres between the distribution node and each of the user stations.

An aim of the present invention is to provide an alternative free space optical communication system.

According to an aspect of the invention, there is provided a signalling system in which a plurality of parallel optical beams convey data between a transmitter and a receiver, resulting in an increase in the total data transmission rate compared with a single optical beam.

Although WO 00/48338 describes a transmitter operable to transmit a plurality of free space optical beams, the lens arrangement in this transmitter is specifically designed so that the transmitted light beams are not parallel but are rather directed to separate receivers.

Exemplary embodiments of the invention will now be described with reference to the accompanying drawings in which:

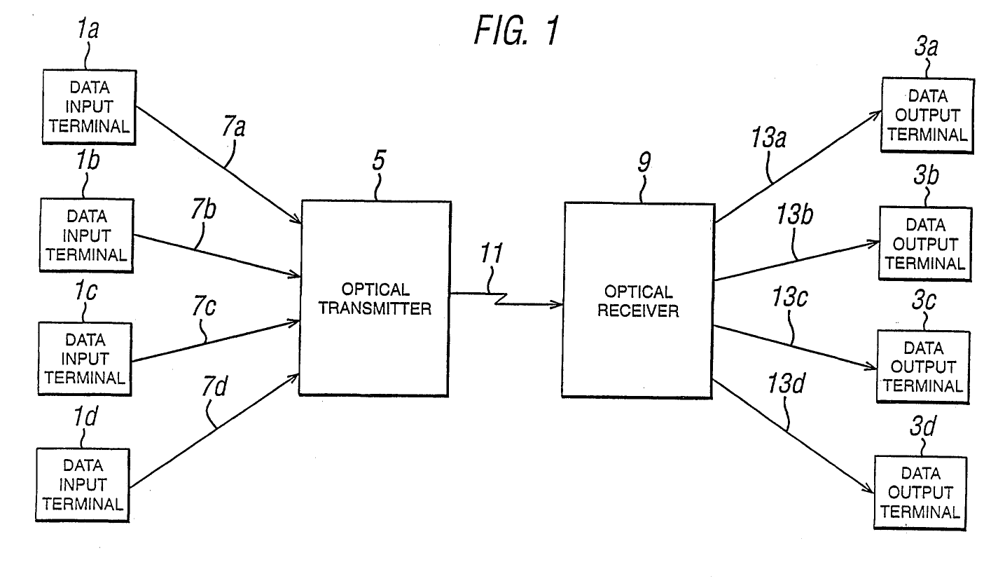

FIG. 1 is a schematic block diagram of a simplex communication system for communicating data from a set of input terminals to a set of output terminals using a point-to-point optical communication link;

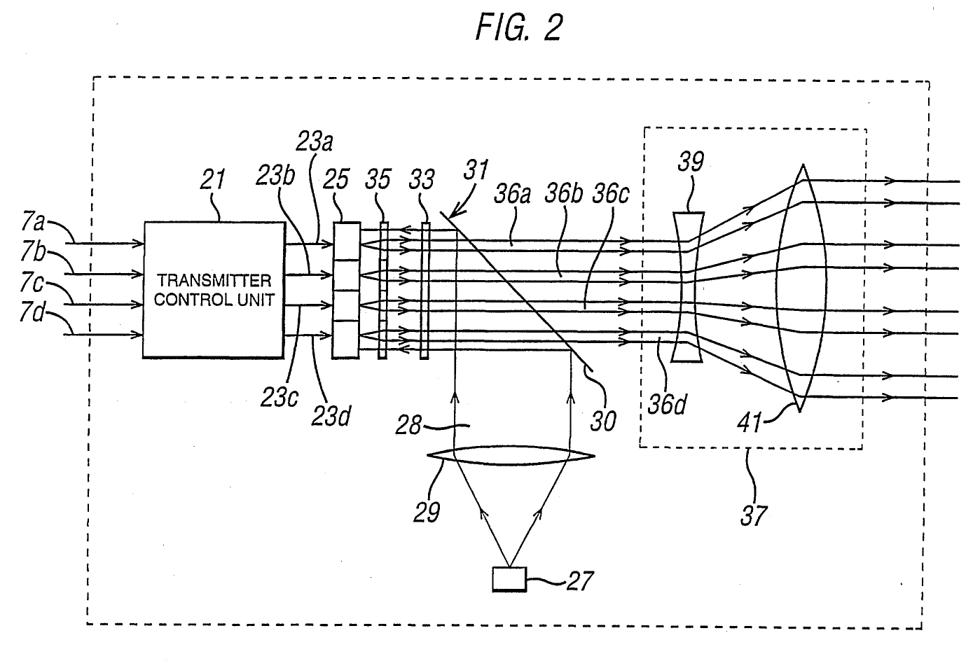

FIG. 2 is a schematic diagram illustrating the form of an optical transmitter shown in FIG. 1;

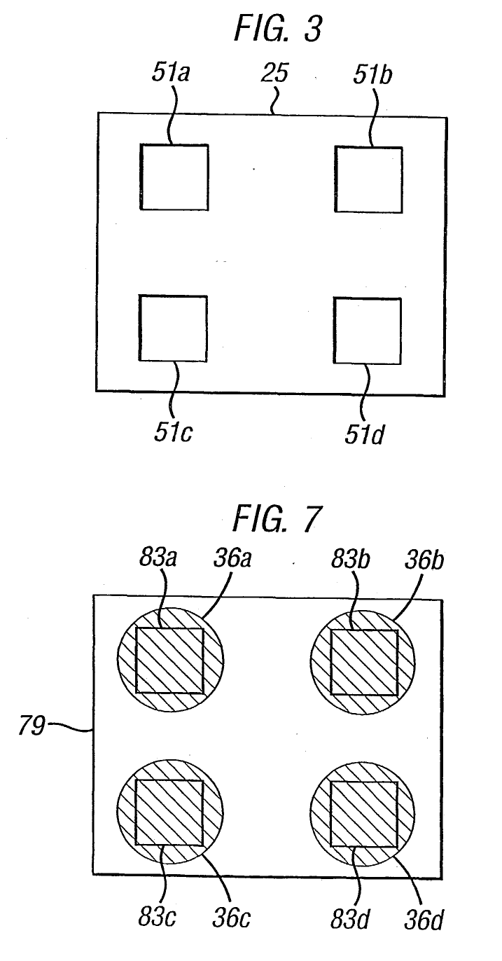

FIG. 3 is a schematic diagram of a pixelated modulator array which forms part of the optical transmitter shown in FIG. 2;

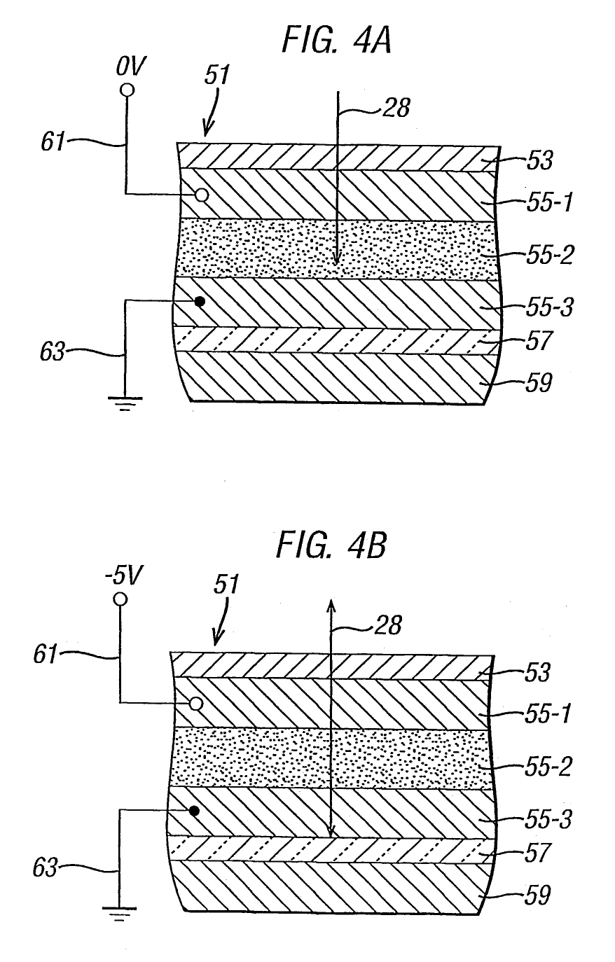

FIG. 4A is a cross-sectional view of one modulator of the pixelated modulator shown in FIG. 3 in a first operational mode when no DC bias is applied to electrodes thereof;

FIG. 4B is a cross-sectional view of one modulator of the pixelated modulator shown in FIG. 3 in a second operational mode when a bias voltage is applied to the electrode;

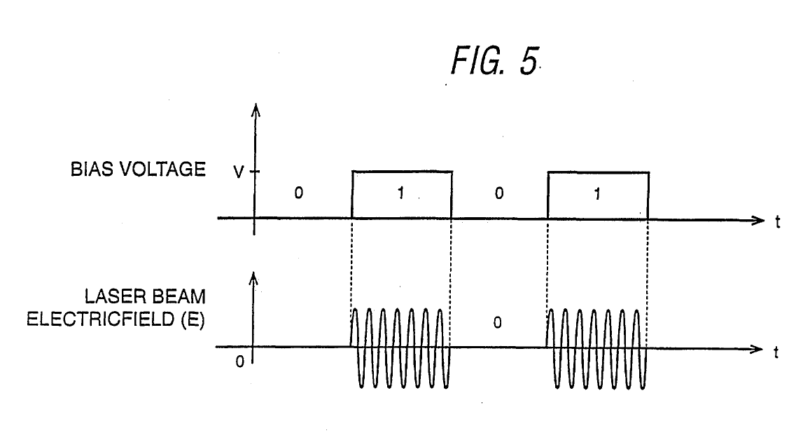

FIG. 5 is a signal diagram which illustrates the way in which the light incident on a pixel of the modulator array shown in FIG. 3 is modulated in dependence upon the bias voltage applied to the pixel electrode;

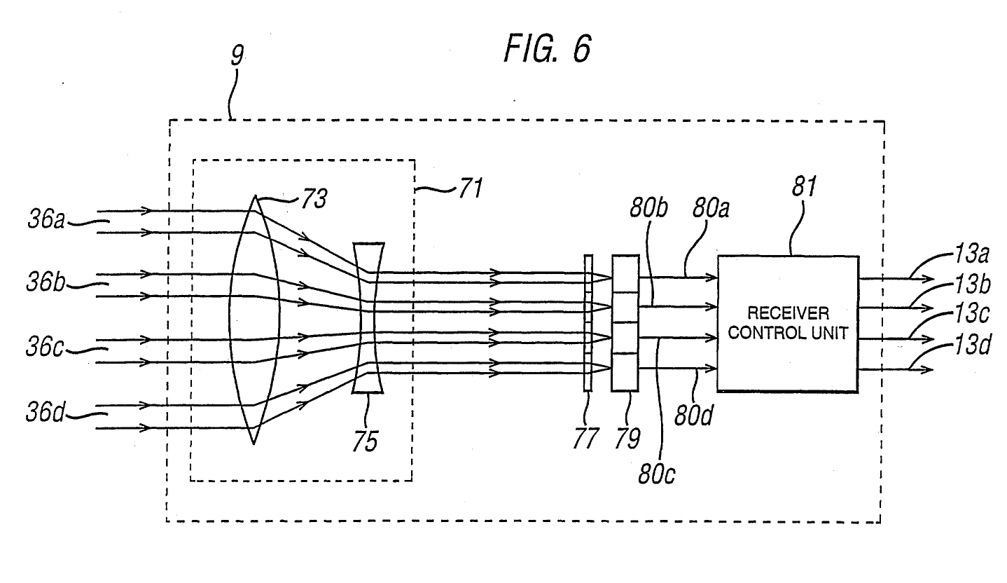

FIG. 6 is a schematic diagram illustrating the form of an optical receiver of the communication system shown in FIG. 1;

FIG. 7 is a schematic diagram of a pixelated detector array which forms part of the optical receiver shown in FIG. 6;

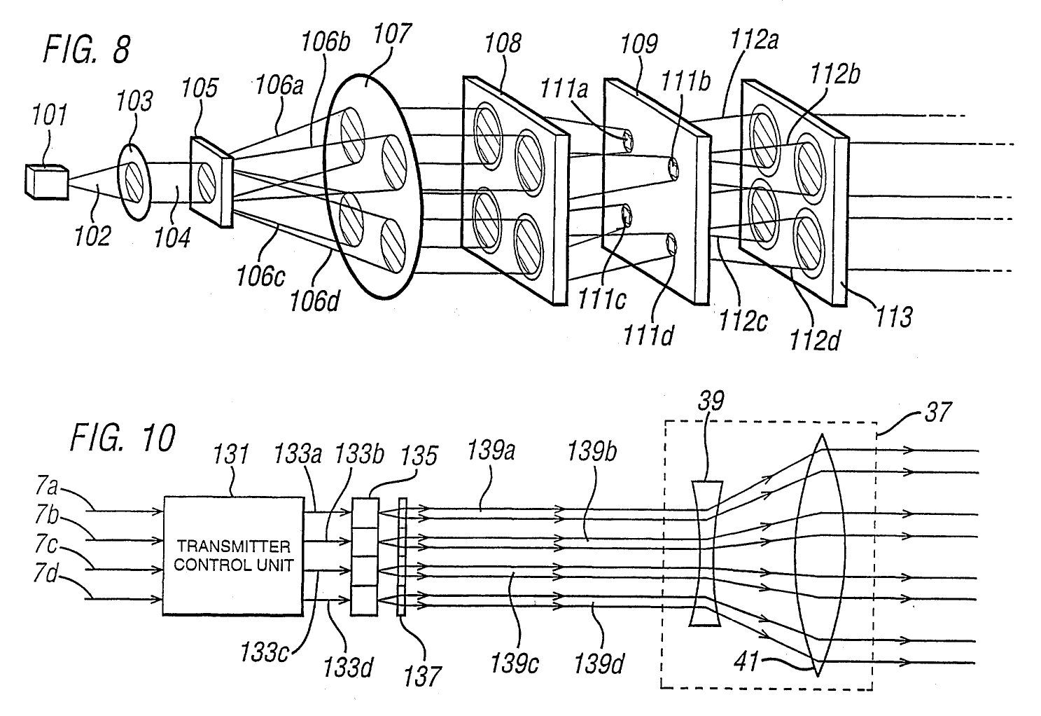

FIG. 8 is perspective schematic view of components of a first alternative optical transmitter for the communication system shown in FIG. 1;

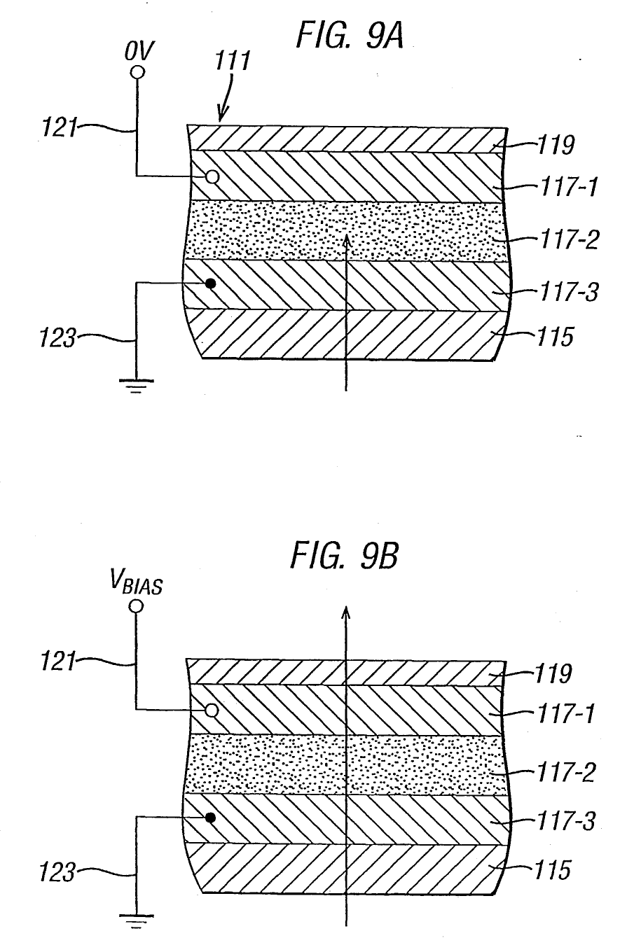

FIG. 9A is a cross-sectional view of one modulator of a pixelated modulator shown in FIG. 8 in a first operational mode when no DC bias is applied to electrodes thereof;

FIG. 9B is a cross-sectional view of one modulator of the pixelated modulator shown in FIG. 8 in a second operational mode when a bias voltage is applied to the electrode;

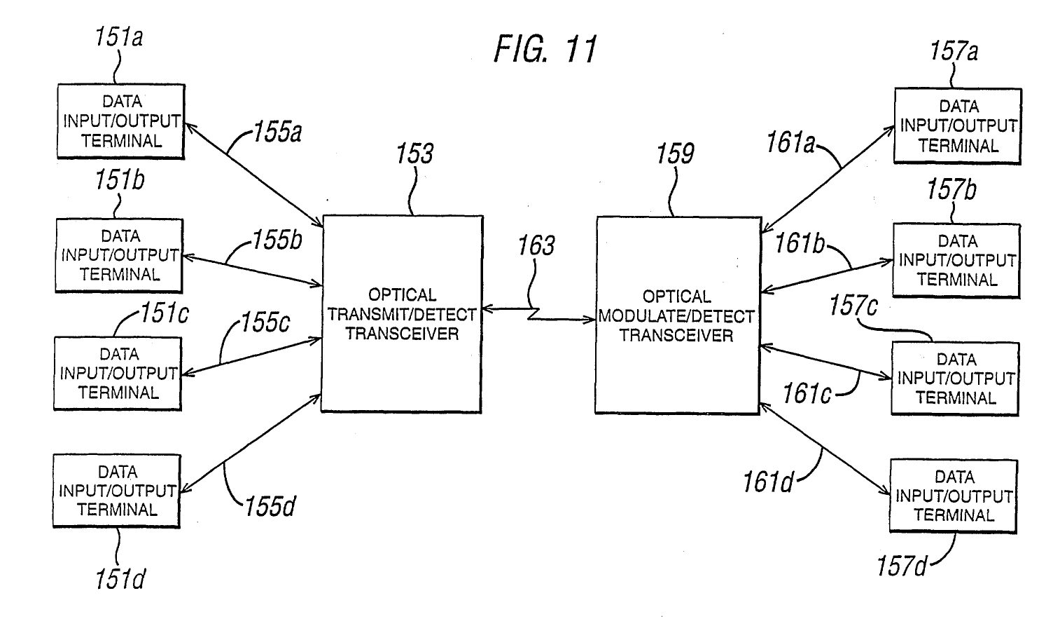

FIG. 10 is a schematic diagram illustrating the form of a second alternative optical transmitter for the communication system shown in FIG. 1;

FIG. 11 is a schematic diagram of a duplex communication system for communicating data between two sets of terminals utilising a point-to-point optical communication link;

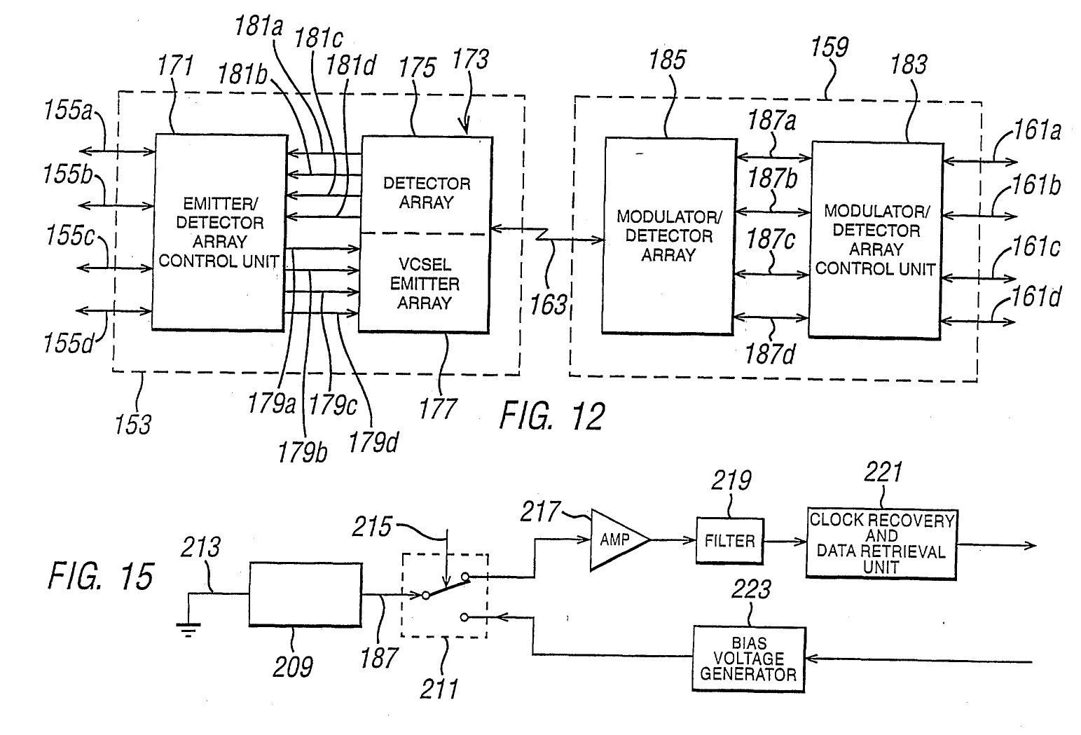

FIG. 12 is a schematic block diagram illustrating the form of an optical transmit/detect transceiver and optical modulate/detect transceiver of the communication system shown in FIG. 11;

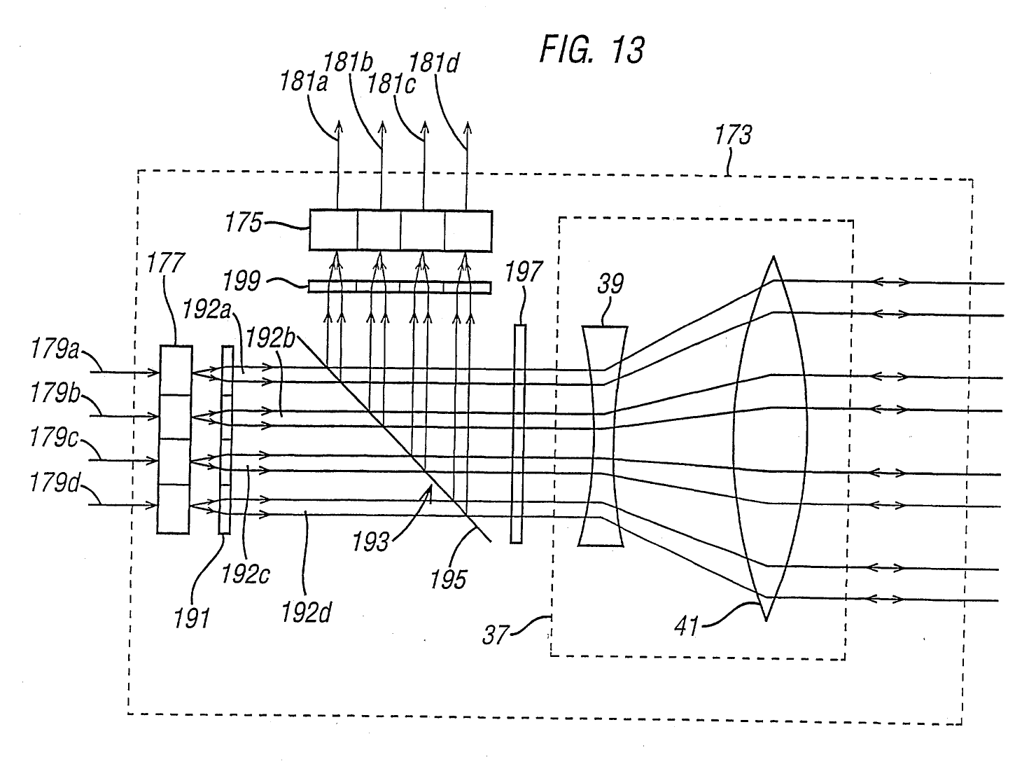

FIG. 13 is a schematic diagram illustrating the form of a detector and emitter array shown in FIG. 12;

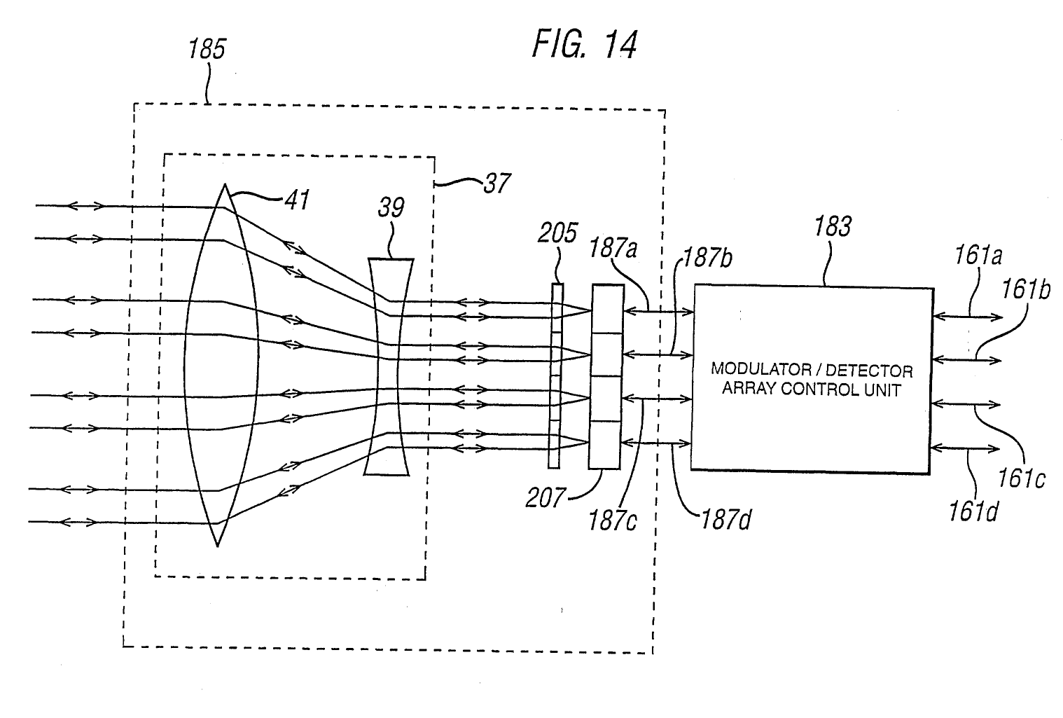

FIG. 14 is a schematic diagram illustrating the form of a modulator/detector array shown in FIG. 12;

FIG. 15 is a schematic block diagram illustrating components of a modulator/detector array control unit shown in FIG. 14;

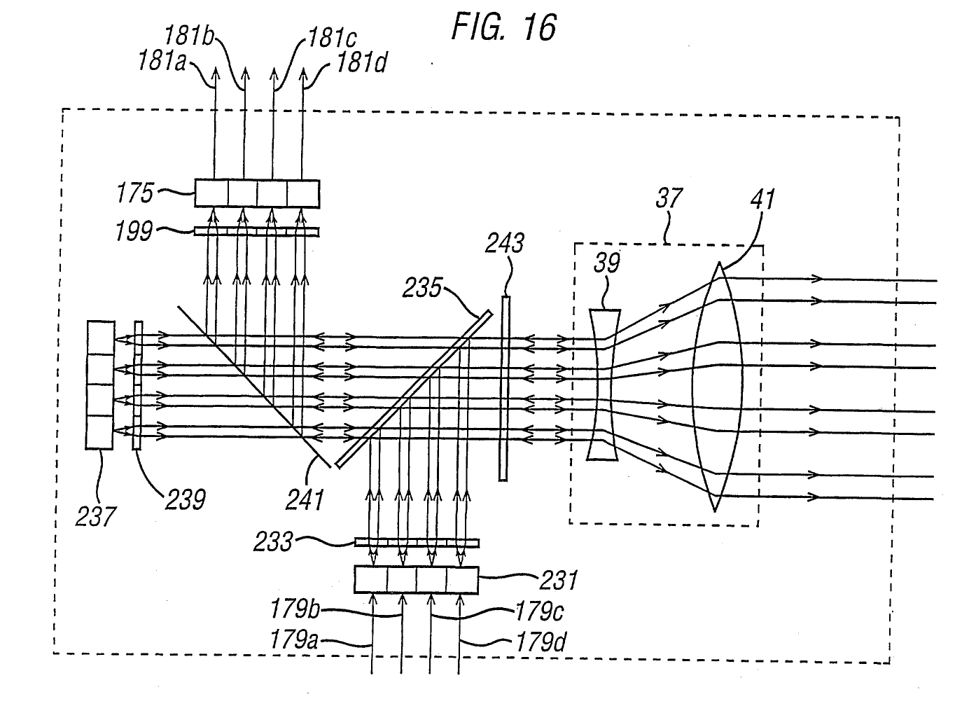

FIG. 16 is a schematic diagram illustrating the form of an alternative detector and emitter array for the optical transmit/detect transceiver shown in FIG. 12;

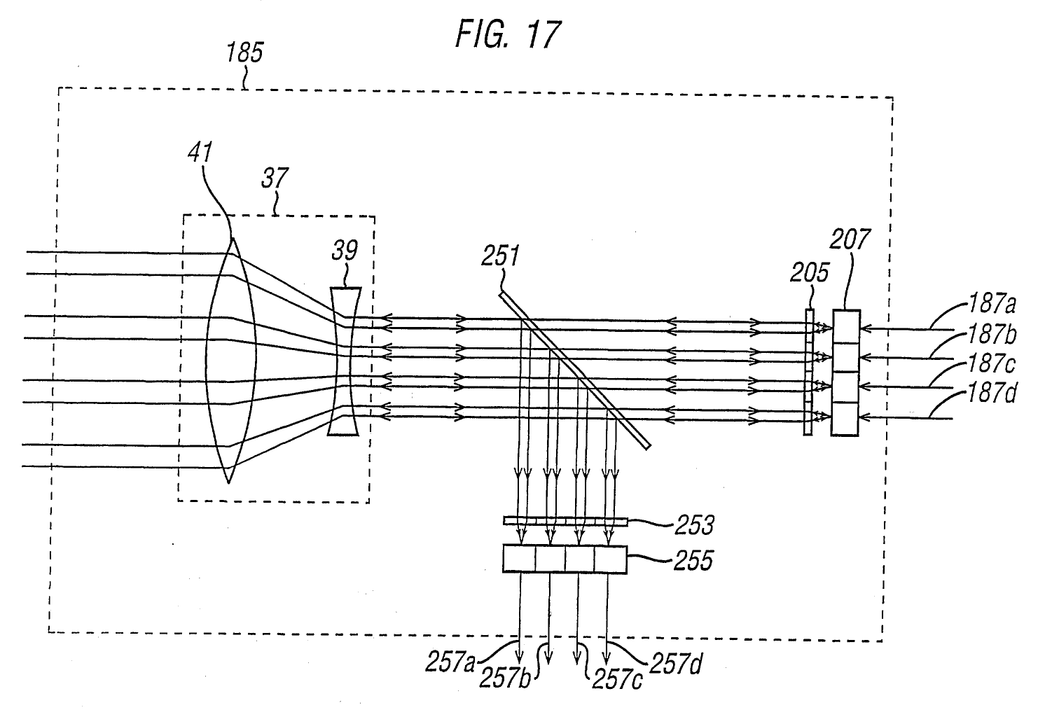

FIG. 17 a schematic diagram showing the form of an alternative modulator/detector array for the optical modulate/detect transceiver shown in FIG. 12; and

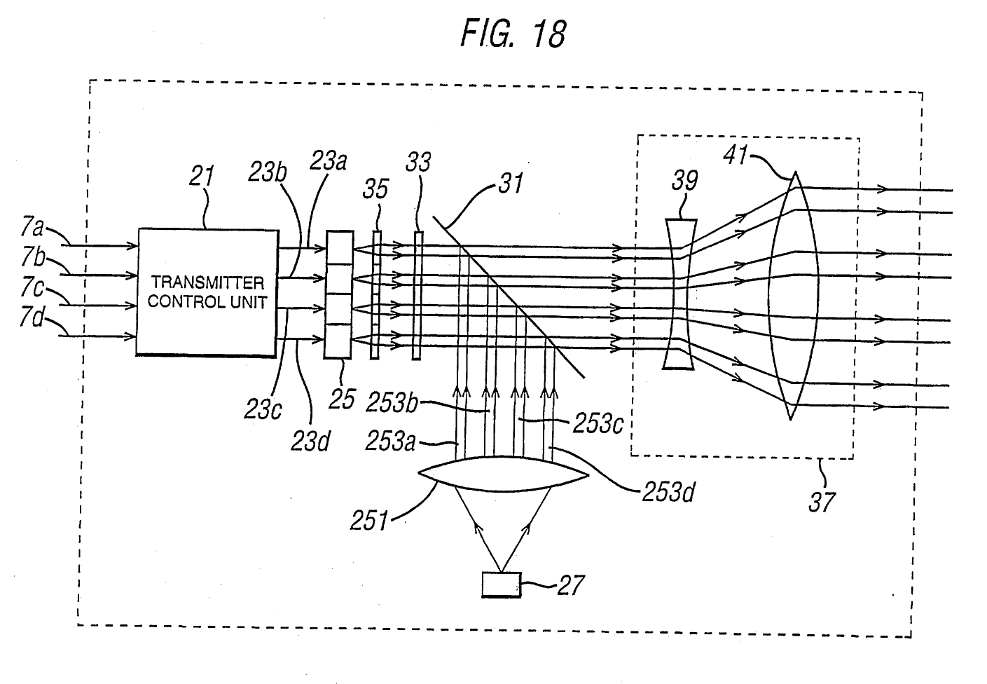

FIG. 18 is a schematic diagram illustrating the form of a third alternative optical transmitter for the communication system shown in FIG. 1.

FIG. 1 schematically illustrates a simplex communication system, forming a first embodiment of the invention, in which data is transmitted from four data input terminals 1a to 1d to one or more of four data output terminals 3a to 3d. The data input terminals 1 are connected to an optical transmitter 5 by respective fibre-optic cables 7a to 7d and the data output terminals 3 are connected to an optical receiver 9 via respective fibre-optic cables 13a to 13d. In accordance with the invention, the optical transmitter 5 transmits data to the optical receiver 9 over an optical link 11 formed by a plurality of parallel optical beams which, in effect, establish a spatially-multiplexed optical link.

In this embodiment, when a user enters data at one of the data input terminals 1, including destination data identifying to which of the four data output terminals the data is to be sent, the input data is transferred over the respective cable 7 to the optical transmitter 5. The optical transmitter 5 then modulates one or more of the parallel light beams in accordance with the input data and the modulated light beam is directed to the optical receiver 9 where it is detected and converted into a corresponding electrical signal. The optical receiver 9 then processes the corresponding electrical signal to recover the input data, reads the destination data and sends the input data to the appropriate data output terminals 3 over the corresponding cables 13.

FIG. 2 schematically illustrates in more detail the main components of the optical transmitter 5 shown in FIG. 1. As shown, the cables 7a to 7d are connected to a transmitter control unit 21. In this embodiment, input data received via the cables 7 is processed by the transmitter control unit 21 to generate four drive signals 23a to 23d which are input to respective elements of a two-by-two pixelated modulator array 25. Each “pixel” of the modulator array 25 comprises a modulator element (not shown) whose reflectivity is determined in accordance with the corresponding drive signal 23.

The optical transmitter 5 also includes a laser diode 27 which emits a linearly-polarised diverging light beam, the divergence being primarily caused by diffraction at the emitting aperture of the laser diode 27. In this embodiment, the wavelength of the light beam emitted by the laser diode is 850 nm. As shown in FIG. 2, the diverging light beam is collected by a collimating lens 29 which substantially collimates the divergent light beam to form a collimated light beam 28. The collimated light beam 28 is then incident on a polarisation separating surface 30 of a polarisation beam splitter 31 which is arranged to reflect the linearly-polarised light beam from the laser diode 27 towards the modulator array 25. The collimated light beam 28 is subsequently incident on a quarter-wave plate 33, which converts the linearly-polarised light into circularly-polarised light, and then a micro-lens array 35.

The micro-lens array 35 comprises a two-by-two array of lens elements positioned so that light incident on each lens element is focussed onto a corresponding one of the modulator elements of the modulator array 25. Each modulator element reflects a proportion of the focussed light which is determined by the corresponding drive signal 23, thereby forming four parallel modulated optical beams 36a to 36d. The modulated light beams 36 are passed back through the corresponding elements of the micro-lens array 35, where they are collimated, and the quarter-wave plate 33, which converts the circularly-polarised light of the modulated light beams 36 into linearly-polarised light whose polarisation is orthogonal to the linearly-polarised light emitted from the laser diode 27. The modulated light beams 36 are then incident on the polarisation beam splitter 31 where they are transmitted through the polarisation separating surface 30 because their polarisation is orthogonal to the polarisation of the light reflected by the polarisation separating surface 30.

After transmission through the polarisation beam splitter, the modulated light beams 36 are then incident on a telescope 37. In this embodiment, the telescope 37 is formed by a concave lens 39 and a convex lens 41. As shown, the modulated light beams 36 are first incident on the concave lens 39, which diverges the light beams 36, and then the convex lens 41 which substantially re-collimates the light beams 36. The purpose of the telescope 37 is to expand the beam size of the modulated light beams 36, which is advantageous for two main reasons. Firstly, by expanding the beam size of the emitted light beams the initial alignment between the optical transmitter 5 and the optical receiver 9 is facilitated. Secondly, by expanding the beam size of the emitted light beams, the integrity of the data conveyed by the light beams is improved because it is less likely that a particle temporarily passing through a light beam will totally disrupt the flow of data.

FIG. 3 shows the surface of the modulator array 25. In this embodiment the modulator array 25 comprises four quantum confined stark effect (QCSE) devices 51a to 51d (which are sometimes also referred to as Self Electro-optic Effect Devices or SEEDS) arranged in a two-by-two array. FIG. 4a schematically illustrates the cross-section of one of the QCSE devices 51. As shown, each QCSE device 51 comprises a transparent window 53, through which the laser beam 28 from the laser diode 27 passes, followed by three layers 55-1, 55-2 and 55-3 of Gallium Arsenide (GaAs) based materials. Layer 55-1 is a p-conductivity type layer, layer 55-2 is an intrinsic layer having a plurality of quantum wells formed therein, and layer 55-3 is an n-conductivity type layer. Together, the three layers 55-1, 55-2 and 55-3 form a p-i-n diode. As shown, the p-conductivity type layer 55-1 is connected to an electrode 61 and the n-conductivity type layer 55-3 is connected to a ground terminal 63. A reflective layer 57, in this embodiment a Bragg reflector, is provided beneath the n-conductivity type layer 55-3, and a substrate layer 59 is provided beneath the reflective layer 57.

In operation, the laser beam 28 from the laser diode 27 passes through the window 53 into the Gallium Arsenide based layers 55. The amount of light absorbed by the intrinsic layer 55-2 depends upon the DC bias voltage applied to the electrode 61. Ideally, when no DC bias is applied to the electrode 61, as illustrated in FIG. 4A, the laser beam passes through the window 53 and is totally absorbed within the intrinsic layer 55-2. Consequently, when there is no DC bias voltage applied to the electrode 61, no light is reflected back towards the polarisation beam splitter 31. On the other hand, when a DC bias voltage of approximately −5 volts is applied to the electrode 61, as illustrated in FIG. 4B, the laser beam 28 from the laser diode 27 passes through the window 53 and the Gallium Arsenide based layers 55 and is reflected by the reflecting layer 57 back upon itself along the same path towards the polarisation beam splitter 31. Therefore, by changing the bias voltage applied to the electrode 61 in accordance with the drive signals 23 determined from the input data from the data input terminals 1, the QCSE device 51 amplitude modulates the light beam from the diode 27 with the received data.

In the ideal case, as illustrated in FIG. 5, a zero voltage bias, resulting in no reflected light, is applied to the electrode 61 to transmit a binary zero and a DC bias voltage of −5 volts is applied to the electrode 61, resulting in the laser beam from the laser diode 27 being reflected back from the QCSE device 51, to transmit a binary one. In practice, however, the QCSE device 51 will reflect typically 70% of the laser beam when no DC bias is applied to the electrode 61, and 95% of the laser beam when −5 volts DC bias is applied to the electrode 61. Therefore, in practice, there will only be a difference of about 25% between the amount of light which is detected by the optical receiver 9 when a binary 0 is being transmitted and the amount of light detected when a binary 1 is being transmitted. The amount of the received light absorbed by the intrinsic layer 55-2 can be increased by adding an additional quantum wells to increase the depth of the intrinsic layer 55-2, However, if the depth of the intrinsic layer 55-2 is increased, then a higher bias voltage must be applied to the electrode 61 in order to produce the required electric field across the intrinsic layer 55-2 which allows light to pass through the intrinsic layer 55-2. There is, therefore, a trade-off between the absorptivity of the intrinsic layer 55-2 and the voltage applied to the electrode 61.

By using the QCSE devices 51, modulation rates of the individual modulator elements in excess of a gigabit per second can be achieved.

FIG. 6 illustrates in more detail the main components of the optical receiver 9 shown in FIG. 1. As shown, the modulated light beams 36 from the optical transmitter 5 are incident on a telescope 71, formed by a convex lens 73 and a concave lens 75, which concentrates the modulated light beams 36 into smaller beam areas. As shown, the modulated light beams 36 are initially converged by the convex lens 73, and then re-collimated by the concave lens 75. Each of the modulated light beams is then incident on a respective lens element of a two-by-two micro-lens array 77. Each lens element of the micro-lens array 77 is positioned to focus the corresponding modulated light beam 36 onto a respective detector element (not shown) of a detector array 79.

In this embodiment, each element of the detector array 79 converts the respective modulated light beam 36 into a corresponding electrical signal, thereby forming four electrical signals 80a to 80d which are-then input to a receiver control unit 81. FIG. 7 shows the detector array 79 in more detail. As shown, the detector array 79 comprises a two-by-two array of photodiodes 83a to 83d and each modulated light beam 36 is focussed to a spot at a respective one of the photodiodes 83.

The receiver control unit 81 receives and amplifies the electrical signals 80 from the photodiodes 83, and the amplified signals are then filtered and supplied to a clock recovery and data retrieval unit which regenerates the clock and the input data using standard data processing techniques. The receiver control unit 81 then reads the destination data in the retrieved input data, and outputs the retrieved input data to the data output terminals 3 specified by the destination data, via the appropriate cables 13.

The main advantage of the first embodiment is that, by providing a plurality of parallel light beams, the rate of data transfer can be increased. This enables, for example, data received from a single data input device 1 to be transmitted over a plurality of light beams or, in an alternative example, data received from a plurality of data input devices is transmitted over respective different optical beams.

In the first embodiment, the micro-lens array 35 in the optical transmitter 5 is used to increase the proportion of the light emitted by the laser diode 27 which is directed onto the QCSE devices 51. However, a significant proportion of the light emitted by the laser diode 27 will nevertheless miss the QCSE devices 51 and will therefore not be modulated, thereby reducing the energy efficiency of the communication system. A second embodiment will now be described with reference to FIGS. 8, 9A and 9B in which a holographic optical element (HOE), sometimes also referred to as a diffractive optical element (DOE), is incorporated into the optical transmitter 5 in order to separate the light beam emitted from the laser diode 27 into an array of light beams, and in which each of the light beams in the array is focussed onto a corresponding transmissive modulator element of a modulator array.

As schematically shown in FIG. 8, a laser diode 101 emits a diverging light beam 102 which is collected and substantially collimated by a collimating lens 103 to form a collimated light beam 104. In this embodiment, the laser diode 101 is formed using indium gallium arsenide (InGaAs) and emits a light beam having a wavelength of 980 nm. The collimated light beam 104 is incident on a holographic optical element 105. Holographic optical elements which convert an incident light beam into an array of light beams are available from MEMS Optical LLC, 205 Import Circle, Huntsville, Ala. 35806, USA. In this embodiment, the HOE 105 converts the collimated light beam 104 into a two-by-two array of diverging light beams 106a to 106d, which are then incident on a lens 107 which substantially collimates the four light beams 106. The four collimated light beams 106 are then incident on respective lens elements of a micro-lens array 108, which focus the light beams 106 onto respective modulator elements 111a to 111d of a two-by-two modulator array 109.

In this embodiment, the amount of light transmitted through each modulator element 111 of the modulator array 109 is modulated in accordance with drive signals generated from the input data, rather than the amount of light reflected as in the first embodiment. Again in this embodiment, each of the modulator elements 111 of the modulator array 109 is a QCSE device. As schematically illustrated in FIG. 9A, each QCSE device 111 is formed on a gallium arsenide substrate 115 which is transparent to light at 920 nm. An n-conductivity type InGaAs layer 117-3 is formed on the substrate 115, an intrinsic InGaAs layer 117-2 having a plurality of quantum wells formed therein is formed on the n-conductivity type layer 117-3, a p-conductivity type InGaAs layer 117-1 is formed on the doped layer 117-2 and a window 119 is formed on the p-conductivity type layer 117-1. As shown in FIG. 9A, an electrode 121 is connected to the p-conductivity type layer 117-1 and a ground terminal 123 is connected to the n-conductivity type layer 117-3.

In operation, the corresponding light beam 106 is incident on the substrate 115 of the modulator element 111, and passes through the substrate 115 and the n-type conductivity layer 117-3. As before, the amount of the light beam absorbed by the intrinsic layer 117-2 depends upon the DC bias voltage applied to the electrode 121. Ideally, when no DC bias voltage is applied to the electrode 121, as shown in FIG. 9A, the intrinsic layer 117-2 absorbs the light beam 106. Consequently, no light is transmitted through the modulator element 111. However, when a bias voltage V_{BIAS} is applied to the electrode 121, the intrinsic layer 117-2 becomes transparent at 920 nm and the light beam 106 passes through the intrinsic layer 117-2, the p-conductivity layer 117-1 and the window 119, and consequently the light beam 106 is transmitted through the modulator element 111. Therefore, by changing the bias voltage applied to the electrode 121 in accordance with the drive signal, the QCSE device 111 amplitude modulates the light beam 106 in accordance with the input data to generate four modulated light beams 112a to 112d.

Those skilled in the art will appreciate that, in practice, the QCSE device 111 does not modulate between fully absorbing and fully transmitting states, but rather introduces a difference of about 15% to 25% in the amount of light which is transmitted through the QCSE device 111 in accordance with the applied bias voltage.

Returning to FIG. 8, the light beams 106 are focussed by the lens 107 at the QCSE devices 111, and therefore the modulated light beams 112 diverge as they leave the modulator elements 111. Each of the modulated light beams is then incident on a respective element of a micro-lens array 113, which collects and substantially collimates the modulated light beams 112, which are then directed, as before, to a telescope (not shown) which expands the modulated optical beams prior to transmission to the optical receiver 9.

The optical receiver 9 for the second embodiment is identical to the optical receiver 9 of the first embodiment as illustrated in FIGS. 6 and 7 and will not, therefore, be described again.

As described above, in the second embodiment a single light beam from a laser diode 101 is split into four separate light beams by an HOE 105 in order to improve the energy efficiency of the communication system. A third embodiment will now be described with reference to FIG. 10 in which four separate light sources are used to generate the four light beams. Components which are the same as corresponding components in the first embodiment have been referred to by the same numerals and will not be described again.

As shown in FIG. 10, the cables 7 from the date input terminals 1 are input to a transmitter control unit 131, which processes the data received via the cables 7 to generate drive signals 133a to 133d for an emitter array 135. In this embodiment, the emitter array 135 comprises a two-by-two pixelated array with a vertical cavity surface emitting laser (VCSEL) positioned in each “pixel”. The use of VCSELs is preferred because the emitter array 135 can then be manufactured from a single semiconductor wafer, without having to cut the wafer, thereby making the emitter array 135 easy to manufacture.

In this embodiment, each VCSEL is driven by a corresponding one of the drive signals 133 and outputs a divergent light beam, the divergence being primarily caused by diffraction at the emitting aperture of the VCSEL, which is modulated in accordance with the corresponding drive signal 133. Each of the divergent light beams emitted by the VCSELs is input to a corresponding lens element of a micro-lens array 137, which collects and substantially collimates the divergent light beam to generate four collimated, modulated light beams 139a to 139d. The four modulated light beams 139 are then incident on a telescope 37 where they are expanded prior to being output from the optical transmitter 5 towards the optical receiver 9.

The optical receiver 9 for the third embodiment is identical to that of the first embodiment and will therefore not be described again.

As those skilled in the art will appreciate, by replacing the single light source, holographic optical element, modulator array and associated optics of the optical transmitter of the second embodiment with the array of VCSEL emitters, the internal optical alignment of the optical transmitter is significantly simplified.

In the first to third embodiments, a simplex communication system was described in which data is sent from a plurality of data input terminals 1 to a plurality of data output terminals 3 using an optical link 11 comprising a plurality of parallel, free-space optical beams. However, the present invention can also be applied to duplex communication systems.

FIG. 11 schematically illustrates a fourth embodiment in which a first set of data input/output terminals 151a to 151d is connected to an optical transmit/detect transceiver 153 via respective cables 155a to 155d, and a second set of data input/output terminals 157a to 157d is connected to an optical modulate/detect transceiver 159 via respective cables 161a to 161d. In this embodiment, the optical transmit/detect transceiver 153 emits parallel light beams which are either modulated to convey information from the optical transmit/detect transceiver 153 to the optical modulate/detect transceiver 159 (hereinafter referred to as the “up-link”), or are unmodulated and are subsequently modulated by the optical modulate/detect transceiver 159 and reflected back to the optical transmit/detect transceiver 153 in order to convey information from the optical modulate/detect transceiver 159 to the optical transmit/detect transceiver 153 (hereinafter referred to as the “down-link”). In this way, a half-duplex optical communication link 163 is established.

FIG. 12 shows the main components of the optical transmit/detect transceiver 153 and the optical modulate/detect transceiver 159 of the fourth embodiment. As shown, the optical transmit/detect transceiver 153 comprises an emitter/detector array control unit 171 and an emitter and detector array 173, formed by a detector array 175 and a VCSEL emitter array 177. As shown, the cables 155 are connected to the emitter/detector array control unit 171. In this embodiment, the VCSEL emitter array 177 is a two-by-two pixelated array with a VCSEL in each pixel and each VCSEL is connected to the emitter/detector array control unit 171 via a respective one of four conductors 179a to 179d and is operable to emit a light beam at 850 nm. In this embodiment, the detector array 173 is a two-by-two pixelated array with a photodiode in each pixel and each photodiode is connected to the emitter/detector array control unit 171 via a respective one of four conductors 181a to 181d.

As shown in FIG. 12, the optical modulate/detect transceiver 159 comprises a modulator/detector array control unit 183 and a modulator/detector array 185. The cables 161a to 161d are connected to the modulator/detector array control unit 183. In this embodiment, the modulator/detector array 185 is a two-by-two pixelated array with a QCSE device having the same structure as the QCSE devices of the first embodiment (described with reference to FIGS. 4A and 4B) in each pixel. Each QCSE device is connected to the modulator/detector array control unit 183 via a respective one of four conductors 187a to 187d. As described with reference to FIGS. 4A and 4B, each QCSE device comprises a p-i-n diode which, in the absence of a bias voltage, absorbs light at 850 nm. This light absorption results in a corresponding electrical current being generated and therefore the QCSE device is also able to act as a light detector.

The emitter/detector array control unit 171 generates drive signals which are sent, via the conductors 179, to the VCSEL emitter array 177. The drive signals cyclically vary between first and second intervals. In the first interval, the drive signals are modulated using data received from the data input/output terminals 151, via the cables 155, so that the VCSEL emitter array 177 emits light beams conveying the data received from the data input/output terminals 151 in the up-link direction. In the second interval, the drive signals 179 cause the VCSEL emitter array 177 to emit unmodulated light beams, which are modulated by the optical modulate/detect transceiver 159 and reflected back to the optical transmit/detect transceiver 153 where they are detected by the detector array 175, thereby conveying data in the down-link direction.

The modulator/detector array control unit 183 is synchronised with the emitter/detector array control unit 171 of the optical transmit/detect transceiver 153 so that in the first interval, the QCSE devices in the modulator/detector array 185 detect the modulated optical beams from the VCSEL emitter array 177, and convert them into corresponding electrical signals (which are transferred along the conductors 187 to the modulator/detector array control unit 183, where they are processed to recover the data from the data input/output terminals 151), and so that in the second interval, the modulator/detector array control unit 183 converts data received, via the cables 161, from the data input/output terminals 157 into corresponding drive signals which are transmitted to the QCSE devices, via the conductors 187, where they modulate the reflectivity of the QCSE devices. In this way, the unmodulated optical beams received from the VCSEL emitter array 177 during the second interval are modulated in accordance with the data from the data input/output terminals 157, and reflected back to the optical transmit/detect transceiver where the detector array 175 of the optical transmit/detect trasceiver 153 converts the modulated light beams into corresponding electrical signals which are transmitted to the emitter/detector array control unit 171, via the conductors 181, where they are processed to recover the data transmitted from the data input/output terminals 157.

FIG. 13 shows in more detail the main components of the emitter and detector array 173. As shown, the conductors 179a to 179d are input to respective pixels of the VCSEL emitter array 177. Each VCSEL emits a linearly-polarised, divergent light beam which is collected and substantially collimated by a respective element of a micro-lens array 191 to generate four light beams 192a to 192d. The light beams 192 are directed to a polarisation beam splitter 193, where they are transmitted through the polarisation separating surface 195. The light beams 192 are then incident on a quarter-wave plate 197 which converts the linearly-polarised light into circularly-polarised light. The light beams 192 of circularly-polarised light are then input to a telescope 37 which, as described with reference to FIG. 2 in the first embodiment, expands the beam size of the light beams 192 prior to the light beams 192 being output from the optical transmit/detect transceiver 153.

The circularly-polarised light beams reflected back from the optical modulate/detect transceiver 159 in the second interval pass back through the telescope 37, which reduces the beam size of the received light beams, and are then incident on the quarter wave plate 197 which converts the circularly-polarised light into linearly-polarised light whose polarisation is orthogonal to that of the light emitted from the VCSEL array 177. The light beams received from the optical modulate/detect transceiver 159 are therefore reflected by the polarisation separating surface 195 of the polarisation beam splitter 193 onto a respective element of a micro-lens array 199. Each element of the micro-lens array 199 is positioned to focus the corresponding incident light beam onto a respective one of the photodiodes of the detector array 175, which converts the reflected light beam into a corresponding electrical signal which is transmitted over the corresponding conductor 181 to the emitter/detector array control unit 171.

FIG. 14 shows the main components of the optical Modulate/detect transceiver 159 of the fourth embodiment. As shown, the modulator/detector array comprises a telescope 37 which, as described with reference to FIG. 2 for the first embodiment, reduces the beam size of the light beams 192 received from the optical transmit/detect transceiver 153. Each of the reduced light beams 192 is then incident on a respective lens element of a micro-lens array 205, which is positioned so that each lens element focusses the corresponding incident light beam onto a respective QCSE device of a modulator array 207. As described above, in the first interval the QCSE devices act as photodiodes and convert the incident light beams 192 into corresponding electrical signals which are processed by the modulator/detector array control unit 183. Whereas, in the second interval the modulator/detector array control unit 183 outputs drive signals which vary the reflectivity of the QCSE devices, and the light beams reflected by the QCSE devices pass back through the micro-lens array 205, where they are re-collimated, and the telescope 37, where their beam sizes are expanded, towards the transmit/detect transceiver 153.

FIG. 15 is a schematic diagram illustrating the main components of the drive circuitry and detection circuitry in the modulator/detector array control unit 183 for a single QCSE device 209 in the modulator array 207. As shown, the conductor 187 (which is connected to the p-conductivity type layer in the QCSE device 209) is connected to a switch 211 and an earthing conductor 213 (which is connected to the n-conductivity type layer of the QCSE device 209) is connected to electrical ground. The position of the switch 211 is controlled by a control signal 215 generated by the modulator/detector array control unit 183. During the first interval, when the QCSE device 209 acts as a photodiode, the control signal 215 connects the terminal 211 to an amplifier 217 (as shown in FIG. 15) which amplifies the electrical signal corresponding to the detected optical beam. The amplified signal is input to a filter 219 and the filtered signal is input to a clock recovery and data retrieval unit 221 which uses standard data processing techniques to recover the up-link data. During the second interval, the control signal 215 controls the position of the switch so that the electrode 211 is connected to a bias voltage generator 223 which applies a bias voltage to the conductor 187 which varies in accordance with the data received from the data input/output terminals 157, in order to modulate the reflectivity of the QCSE device 209.

As described above, in the fourth embodiment a half duplex optical communication link is established in which data is transmitted in the up-link direction during a first interval and data is transmitted in the down-link direction during a second interval. A fifth embodiment will now be described with reference to FIGS. 16 and 17 in which a full duplex optical communications link is established, i.e. a communications link in which data can be transmitted in the up-link and down-link directions simultaneously. In particular, in the fifth embodiment light beams having a first wavelength are used to transmit data from the optical transmit/detect transceiver 153 to the optical modulate/detect transceiver 159, and light beams having a second wavelength (different from the first wavelength) are used to transmit data from the optical modulate/detect transceiver 159 to the optical transmit/detect transceiver 153.

FIG. 16 shows the main components of the emitter and detector array 173 of the fifth embodiment. Components in FIG. 16 which are the same as corresponding components in the fourth embodiment have been referenced by the same numerals and will not be described again.

In this embodiment, the conductors 179, which convey drive signals which are modulated in accordance with data received from the data input/output devices 151, are connected to a first VCSEL emitter array 231 which emits four parallel light beams having a wavelength of 870 nm. The divergent light beams emitted by the first VCSEL array 231 are collimated by a micro-lens array 233 and are directed onto a dichroic plate 235. A second VCSEL emitter array 237 emits unmodulated, linearly-polarised, light beams having a wavelength of 850 nm. The divergent light beams emitted by the second VCSEL emitter array are collimated by a micro-lens array 239, transmitted through a polarisation beam splitter 241, and are then incident on the dichroic plate 235.

The transmission spectrum of the dichroic plate 235 is set to transmit the optical beams from the second VCSEL emitter array 237 and reflect the optical beams from the first VCSEL emitter array 231. In this embodiment, the positions of the first and second VCSEL emitter arrays 231, 237 (and their respective micro-lens arrays 233, 239) and the dichroic plate 235 are set so that the light beams from the first VCSEL emitter array 231 reflected by the dichroic plate 235 and the light beams from the second VCSEL array 237 transmitted by the dichroic plate 235 overlap.

The overlapping light beams are then incident on a quarter wave plate 243 which is matched to a wavelength of 850 nm and therefore converts the linearly-polarised light from the second VCSEL emitter array 237 into circularly-polarised light, while the light from the first VCSEL array is converted into elliptically polarised light. The overlapping light beams then pass through the telescope 37, where their beam sizes are expanded, and are directed to the optical modulate/detect transceiver 159.

FIG. 17 shows the main components of the modulator/detector array 185. Components which are the same as those in the fourth embodiment have been referenced by the same numerals and will not be described again. As shown, the overlapping light beams from the optical transmit/detect transceiver 153 are concentrated by the telescope 37 and are directed onto a dichroic plate 251. The transmission spectrum of the dichroic plate 251 is set to reflect the modulated light at 870 nm from the first VCSEL emitter array 231 and to transmit the unmodulated light at 850 nm from the second VCSEL emitter array 237. The light beams reflected by the dichroic plate 251 are directed onto respective elements of a micro-lens array 253, which focus the beams onto respective detector elements of a detector array 255. In this embodiment, each detector element comprises a photodiode which converts incident light into corresponding electrical signals which are output to the modulator/detector array control unit 183 via conductors 257a to 257d. In this way data is transmitted in the uplink direction.

The unmodulated light beams transmitted through the dichroic plate 251 are incident on respective elements of the micro-lens array 205, which focus the light beams onto respective QCSE devices of the modulator array 207.

The reflectivity of each QCSE device of the modulator array 207 is varied in accordance with drive signals received from the modulator/detector array control unit 183 over the corresponding conductor 187. The reflected light beams are then re-collimated by the micro-lens array 205, passed back through the dichroic plate 251 and expanded by the telescope 37 before being transmitted back to the optical transmit/detect transceiver 153. At the optical transmit/detect transceiver 153, the modulated light beams from the optical modulate/detect transceiver 159 are concentrated by the telescope 37 and are then converted by the quarter-wave plate 235 into linearly-polarised light whose polarisation is orthogonal to the light emitted by the second VCSEL emitter array 237. The light beams from the optical modulate/detect transceiver 159 therefore pass through the dichroic plate 231 and are reflected by the polarisation beam splitter 241 onto the detector array 175, via the micro lens array 199. The detector elements in the detector array operate to convert the modulated light beams into corresponding electrical signals which are passed back to the control unit. In this way, data is transmitted in the down-link direction.

It will be appreciated that by using light beams of different wavelengths for the up-link and the down-link, the emitter/detector array control unit and the modulator/detector array control unit can continuously supply modulated drive signals to both the first VCSEL emitter array 177 and the modulator array 207 in order to transfer data in the up-link and the down-link directions simultaneously.

Modifications and Further Embodiments

In the above-described embodiments, optical links having four light beams spatially separated in a two-by-two array have been described. Those skilled in the art will appreciate that larger arrays containing more light beams can be used to enable the optical link to transfer data at a higher rate. For example, an eight-by-eight array of light beams could be used. Further, the shape of the array is a design choice and, for example, a linear array of light beams or could be generated.

Those skilled in the art will appreciate that as the number of light beams in the optical link increases, the use of a QCSE device array is increasingly preferred over the use of a VCSEL emitter array because the QCSE device arrays are easier to implement than the VCSEL emitter arrays as they are easier to fabricate and thermal loading is not so problematic.

For the embodiments which employ an array of VCSEL emitters, the spatial separation between individual VCSELs is preferably maximised, within the constraints of the design specification, in order both to improve the ability of the VCSEL emitter array to handle the thermal load and to improve the spatial separation of the light beams, which has the advantage of reducing cross-talk caused by light from one light beam being detected by a detector corresponding to another light beam. Further, in all the embodiments it is advantageous to spatially separate the light beams as much as possible to avoid cross-talk.

Those skilled in the art will appreciate that the micro-lens arrays in front of the QCSE device arrays and the detector arrays in the above embodiments are not essential, but are preferred because they increase the amount of light falling on the active areas of the devices.

In the second embodiment, the laser light used in the optical link is 980 nm to ensure that the light beams are transmitted through the Gallium Arsenide substrate of the QCSE devices. However, laser light at 850 nm could be used if the QCSE devices were formed on a gallium arsenide substrate, then transferred to a glass substrate and the gallium arsenide substrate removed.

Those skilled in the art will appreciate that the optical links can use light beams at wavelengths other than 850 nm and 980 nm, although it is preferred that infra-red light is used due to the availability of sources and detectors in this wavelength region. In particular, it is preferred that light having a wavelength in the range of 750 nm to 2 μm is used due to the availability of semiconductor light emitters, detectors and modulators. For example, in an embodiment light beams at about 1.5 microns could be used which is advantageous because at this wavelength light sources and light detectors are relatively cheap and the light beams are “eye-safe”.

A modulator array as used in the first embodiment (with modulator elements as illustrated in FIGS. 4A and 4B) can also be used in an optical transmitter in which an HOE splits a single incident light beam at 850 nm into a plurality of parallel, spaced light beams. FIG. 18 shows the main components of such an optical transmitter in which components which are the same as corresponding components in FIG. 2 have been referenced by the same numerals and will not be described again. As shown, the collimating lens 29 of FIG. 2 is replaced by an HOE 251 which converts the divergent light beam emitter by the laser diode 27 into four parallel light beams 253a to 253d. Although the HOE 251 is shown as a single element in FIG. 18, those skilled in the art will appreciate that in practice the HOE 251 will be composed of a number of elements.

Each of the laser beams 253 is reflected by the polarisation beam splitter 31, directed through the quarter-wave plate 33, and then focussed by the micro-lens array 235 onto a corresponding QCSE device of the modulator array 25, which modulates and reflects the light beam 253 as before.

Although embodiments using QCSE devices to modulate the light beams are described above, those skilled in the art will appreciate that other modulators could be used. For example, liquid crystal devices could be used, although this is not preferred because of the low modulation rates available with liquid crystal devices in comparison with QCSE devices.

In the first and second embodiments, the optical transmitter 5 houses both a light source and modulators for modulating light emitted by the light source. Those skilled in the art will appreciate that the light source could be provided in the optical receiver 9, with the modulators in the optical transmitter 5 acting as retro-reflectors.

In the fourth embodiment, a half duplex link is established in which up-link data is transmitted in a first interval and down-link data is transmitted in a second interval. Generally, the duration of the first and second intervals will be the same. However, if there is more up-link data to be transmitted than down-link data then the first interval can be made longer than the second interval. Alternatively, if more down-link data is to be transmitted than up-link data then the second interval can be made longer than the first interval.

In the fifth embodiment, a full duplex link is achieved by using different wavelengths for the up-link and the down-link. Alternatively, a full duplex optical link can be achieved by using light of orthogonal polarisations for the up-link and the down-link and replacing the dichroic plates with polarisation beam splitters. In another alternative embodiment, a full duplex link can be established by using light beams for the up-link which are spatially separated from the light beams for the down-link.

As those skilled in art will appreciate, a full duplex optical link can also be established by using a VCSEL emitter array at both ends of the optical link. Alternatively, a full duplex optical link can be established by using a light source and a QCSE device array, as in either the first or the second embodiments, at both ends of the optical link.

As those skilled in the art will appreciate, it is not necessary for each of the light beams in the described optical links to be dedicated to a particular source of data, but rather the transmitter circuitry can allocate data to one or more optical links. The transmitters can also perform conventional encoding techniques to reduce the bit error rate of the optical link. Further, each light beam in the optical link can be modulated to convey data using time division multiplexing or wavelength division multiplexing. Alternatively, different light beams in the optical link could have different wavelengths.

The use of spatially-separated parallel light beams allows a new and advantageous encoding technique in which the same data is conveyed by two or more of the light beams, either simultaneously or in a time-staggered fashion. This new encoding technique is particularly advantageous because if one of the laser beams is interrupted, for example by a rain drop, then the data can still safely be conveyed by a different light beam.

Those skilled in the art will appreciate that this is problem which is particular to free-space optical links and has no counterpart in optical fibre links.

In the above embodiments, each laser beam conveys a separate serial stream of data. Alternatively, the plurality of laser beams can be used to convey a parallel data stream, for example sixteen light beams can be used to convey 16-bit words. Those skilled in the art will appreciate that the number of bits in the words is a design choice and could be, for example, 8 bits or 32 bits. The use of free-space optical beams to convey parallel data streams is preferred over using parallel arrays of optical fibres because if optical fibres are used then each optical fibre must be of precisely the same length in order to achieve high data rates, which is in practice extremely difficult to achieve.

Although in the described embodiments, each end of the parallel, multi-beam optical links is connected to a plurality of data input and/or output devices by fibre-optic cables, alternatively conductor cables (for example, co-axial copper cables) or point-to-multipoint optical communication links as described in WO 98/35328 and WO 00/48338 could be used. Further, the parallel multi-beam optical link could connect a single data input and/or output device to either another single data input and/or output device or a plurality of data input and/or output devices.

The parallel multi-beam, free-space optical links described above are particularly advantageous for use in environments such as in nuclear reactors or particle colliders where the high levels of ionising radiation cause the attenuation of optical fibres to increase with time. In particular, in a particle collider a very large amount of data is generated in a very short time and therefore the high data rates possible with the parallel multi-beam, free-space optical links described above make them particularly advantageous for this application.

As described above, the present invention provides an optical communication link between a first signalling device and a second signalling device in which a plurality of spatially-separated, parallel, free-space light beams are modulated to convey information, with each light beam emitted-by the first signalling device being uniquely matched to a corresponding detector in the second signalling device.

1. A free-space optical signalling system comprising first and second signalling devices, one of the first and second signalling devices comprising means for generating one or more light beams,
the first signalling device comprising: i) means for receiving data for transmission to the second signalling device; ii) means for modulating said one or more light beams in accordance with the received data so as to generate a plurality of modulated light beams; and iii) one or more lenses arranged so that the plurality of modulated light beams are output from the first signalling device towards the second signalling device as substantially collimated, spatially-separated, parallel, free-space light beams,
and the second signalling device comprising: i) a plurality of detectors which are spatially separated for detecting respective different ones of said plurality of modulated light beams output by the first signalling device and for converting the modulated light beams into corresponding electrical signals, and ii) means for processing the corresponding electrical signals to recover said data.

2. A signalling system according to claim 1, wherein said modulating means comprises a plurality of modulator elements for respectively generating said plurality of modulated light beams.

3. A signalling system according to claim 2, wherein the modulating means is operable to vary the reflectivity of each modulator element in accordance with the data for transmission to the second signalling device.

4. A signalling system according to claim 3, wherein said light generating means comprises a light source operable to emit a single light beam, and wherein the plurality of modulator elements are operable to generate said plurality of modulated light beams by reflecting different portions of said single light beam.

5. A signalling system according to claim 4, wherein said one or more lenses comprise a lens array having a plurality of lens elements, each lens element being positioned so as to focus a corresponding part of the single light beam onto a respective modulator element.

6. A signalling system according to claim 5, wherein said first signalling device comprises said light source, and said one or more lenses further comprise a lens positioned so as to substantially collimate said single light beam to form a single collimated light beam which is incident on the lens array so that the plurality of lens elements are operable to substantially collimate the plurality of modulated light beams reflected by the respective modulator elements.

7. A signalling system according to claim 4, wherein the first signalling device comprises:
the light source;
means for splitting said single light beam into a plurality of split light beams; and
means for directing each of the split light beams onto a respective modulator element of said array of modulator elements.

8. A signalling system according to claim 7, wherein said one or more lenses comprises a lens array having a plurality of lens elements, each lens element being positioned so as to focus a respective one of the plurality of split light beams onto a corresponding modulator element.

9. A signalling system according to claim 8, wherein said one or more lenses further comprises means for substantially collimating the plurality of split light beams.

10. A signalling system according to any of claims 7 to 9, wherein the splitting means comprises a holographic optical element.

11. A signalling system according to claim 2, wherein the first signalling device comprises the light generating means, and wherein said modulating means is operable to vary the transmittance of each modulator element in accordance with the data for transmission to the second signalling device.

12. A signalling system according to claim 11, wherein the light generating means comprises a light source operable to emit a single light beam, and wherein the first signalling device further comprises means for directing the single light beam onto the modulating means.

13. A signalling system according to claim 12, wherein the one or more lenses comprise:
a first lens array positioned in the optical path between the light source and the modulating means, the first lens array having a plurality of lens elements positioned so as to focus corresponding parts of the collimated light beam onto respective modulator elements; and
a second lens array positioned to receive the modulated light beams transmitted through the modulating means, the second lens array having a plurality of lens elements positioned so as to substantially collimate respective ones of the plurality of modulated light beams.

14. A signalling system according to claim 12, wherein the first signalling device further comprises:
means for splitting said single light beam into a plurality of split light beams; and
means for directing the plurality of split light beams onto respective different modulator elements of said array of modulator elements.

15. A signalling system according to claim 14, wherein said one or more lenses comprise:
a first lens array positioned in the optical path between the light splitting means and the modulating means, the first lens array having a plurality of lens elements positioned so as to focus respective ones of the plurality of split light beams onto respective modulator elements; and
a second lens array positioned to receive the plurality of modulated light beams transmitted through the modulating means, the second lens array having a plurality of lens elements positioned so as to substantially collimate respective ones of the plurality of modulated light beams.

16. A signalling system according to either claim 14 or 15, wherein the splitting means comprises a holographic optical element.

17. A signalling system according to any preceding claim, wherein the modulating means comprises an electro-optic device operable to receive an electrical drive signal which modulates an optical property of the electro-optical device in accordance with the received data.

18. A signalling system according to claim 17, wherein the modulating means comprises one or more quantum-confined Stark effect devices.

19. A signalling system according to any of claims 2 to 18, further comprising means for generating drive signals for the modulator elements in accordance with the received data.

20. A signalling system according to claim 1, wherein the first signalling device comprises the light generating means, wherein the light generating means comprises a plurality of light emitting elements, and wherein said modulating means is operable to modulate the light emitted by each light emitting element in accordance with said received data in order to generate said plurality of modulated light beams.

21. A signalling system according to claim 20, wherein the plurality of light emitting elements are integrated in a single device.

22. A signalling device according to claim 21, wherein one or more of the light emitting elements comprises a vertical cavity surface emitting laser.

23. A signalling device according to claim 22, wherein the modulating means is operable to modulate a drive current applied to the vertical cavity surface emitting laser in accordance with the received data.

24. A signalling system according to any of claims 20 to 23, wherein said one or more lenses comprise a lens array having a plurality of lens elements, each lens element being operable to substantially collimate light emitted from a respective light emitting element.

25. A signalling system according to any preceding claim, wherein said data received by said receiving means of the first signalling device for transmission to the second signalling device is up-link data, wherein the second signalling device further
comprises: i) receiving means for receiving down-link data for transmission to the first signalling device; ii) means for modulating one or more light beams in accordance with the down-link data to generate a plurality of modulated light beams; and iii) one or more lenses arranged so that the plurality of modulated light beams are output from the second signalling device towards the first signalling device as substantially collimated, spatially-separated, parallel, free-space light beams,
and wherein the first signalling device further comprises: i) a plurality of detectors operable to detect respective ones of said plurality of modulated light beams output by the second signalling device and to convert the respective modulated light beams into corresponding electrical signals; and ii) means for processing the corresponding electrical signals to recover the down-link data.

26. A signalling system according to claim 25, wherein the first signalling device comprises the light generating means, and wherein said first and second signalling devices synchronously alternate between a first mode in which the plurality of light beams emitted by the first signalling device are modulated to convey up-link data to the second signalling device, and a second mode in which the plurality of light beams emitted by the first signalling device are unmodulated and the modulating means of the second signalling device is operable to modulate the plurality of unmodulated light beam from the first signalling device in accordance with the down-link data and said one or more lenses of the second signalling device direct the modulated light beams towards the first signalling device to convey the downlink data to the first signalling device.

27. A signalling system according to claim 26, wherein the modulating means of the second signalling device comprises a plurality of modulating elements,
and wherein each of the plurality of modulating elements comprise a device common to both the modulator element and a respective one of the plurality of detectors of said second signalling device, the common device being operable to detect a corresponding one of the plurality of modulated light beams from the first signalling device in the first mode and to modulate a corresponding one of the plurality of unmodulated light beams from the first signalling device in the second mode.

28. A signalling system according to claim 27, wherein the common device is a quantum-confined Stark effect device.

29. A signalling system according to claim 25, wherein said light generating means is a first light generating means which is operable to emit light having a first wavelength,
wherein one of the first and second signalling devices comprises a second light generating means for emitting light having a second wavelength different to the first wavelength,
wherein modulating means of the first signalling device is operable to generate the plurality of modulated light beams of the first signalling device using light having the first wavelength and the modulating means of the second signalling device is operable to generate the plurality of modulated light beams of the second signalling device using light having the second wavelength.

30. A signalling system according to claim 29, wherein the first signalling device comprises the first and second light generating means.

31. A signalling system according to claim 25, wherein the plurality of parallel, free-space light beams output by the first signalling device has a polarisation orthogonal to the plurality of parallel, free-space light beams output by the second signalling device.

32. A signalling system according to any of claims 25 to 31, wherein the one or more lenses of the first signalling device and the one or more lenses of the second signalling device are arranged so that the plurality of parallel, free-space light beams output by the first and second signalling devices overlap.

33. A signalling system according to any of claims 25 to 31, wherein the one or more lenses of the first signalling device and the one or more lenses of the second signalling device are arranged so that the plurality of parallel, free-space light beams output by the first signalling device are spatially separated from the plurality of parallel free-space light beams emitted by the second signalling device.

34. A signalling system according to any preceding claim, wherein at least one of the first and second signalling devices is operable to transmit data as a stream of data words having a plurality of elements, each data word element being transmitted by a respective modulated light beam.

35. A signalling system according to claim 34, wherein the receiving means said at least one of the first and second signalling devices is operable to receive a serial stream of data and to convert the serial stream of data into said stream of data words.

36. A signalling system according to any preceding claim, wherein said one or more lenses of a least one of the first and second signalling devices are arranged to output the corresponding plurality of substantially collimated, spatially-separated, parallel, free-space light beams as a regular array.

37. A signalling system according to claim 36, wherein the regular array is a two-dimensional array.

38. A signalling system according to any preceding claim, wherein said one or more lenses of at least one of the first and second signalling devices comprise a lens system for expanding the beam size of the corresponding plurality of modulated light beams output by the signalling device.

39. A signalling system according to any preceding claim, wherein said one or more lenses of at least one of the first and second signalling devices comprise a lens system for reducing the beam size of the plurality of modulated light beams received from the other signalling device.

40. A signalling system according to claim 38, wherein said lens system is operable to reduce the beam size of the plurality of modulated light beams received from the other signalling device.

41. A signalling system according to any preceding claim, wherein said light generating means is operable to generate infra-red light.

42. A signalling system according to any preceding claim, wherein said light generating means comprises a plurality of light sources operable to emit light beams at respective different wavelengths, and wherein the modulating means is operable to modulate light beams of different wavelengths in accordance with respective data.

43. A signalling device comprising the technical features of the first signalling device as claimed in any preceding claim.

44. A signalling device comprising the technical features of the second signalling device as claimed in any of claims 1 to 42.

45. An optical signalling device comprising:
at least one input port for receiving data;
a modulator operable to modulate at least one infrared light beam in accordance with the received data to generate a plurality of modulated infra-red light beams; and
at least one optical element arranged so that the plurality of modulated infra-red light beams are output by the optical signalling device as substantially collimated, spatially-separated, parallel, free-space light beams.

46. An optical signalling device comprising:
a plurality of spatially-separated detectors operable to convert respective incident light beams into corresponding electrical signals; and
at least one optical element operable to direct a plurality of substantially collimated, spatially-separated, parallel, free-space light beams incident on the optical signalling device onto respective ones of the plurality of spatially-separated detectors,
wherein said free-space light beams are modulated to convey information and the optical signalling device further comprises a circuit operable to process said corresponding electrical signals to recover said conveyed information.

47. An optical signalling device comprising:
means for receiving data;
means for modulating one or more light beams in accordance with the received data so as to generate a plurality of modulated light beams;
a plurality of spatially-separated detectors; and
at least one optical element arranged so that: i) the plurality of light beams modulated by the modulating means are output from the optical signalling device as substantially collimated, spatially-separated, parallel, free-space light beams; and ii) a plurality of substantially collimated, spatially-separated, parallel, free-space light beams incident on the optical signalling device are directed onto respective ones of the plurality of spatially-separated detectors,
wherein said incident free-space light beams are modulated to convey information and the optical signalling device further comprises a circuit operable to process said corresponding electrical signals to recover said conveyed information.

48. An optical signalling device comprising:
means for receiving data;
means for modulating one or more light beams in accordance with the received data so as to generate a plurality of modulated light beams;
a plurality of spatially-separated detectors; and
at least one optical element operable: i) to output the plurality of light beams modulated by the modulating means are output from the optical signalling device in a predetermined direction as substantially collimated, spatially-separated, parallel, free-space light beams; and ii) to direct a plurality of substantially collimated, spatially-separated, parallel, free-space light beams incident on the optical signalling device from the predetermined direction onto respective ones of the plurality of spatially-separated detectors.
